(19) United States
(12) Patent Application Publication
(10) Pub. No.: US 2023/0403432 A1
(43) Pub. Date: Dec. 14, 2023

(54) SYSTEMS AND METHODS FOR RESTRICTING VIDEO CONTENT

(71) Applicant: Microsoft Technology Licensing, LLC, Redmond, WA (US)

(72) Inventor: Prabhakaran SETHURAMAN, Redmond, WA (US)

(21) Appl. No.: 17/839,271

(22) Filed: Jun. 13, 2022

(51) Int. Cl. H04N 21/466; G06F 16/735; H04N 21/25; H04N 21/45; H04N 21/2347

(52) U.S. Cl. CPC H04N 21/4668; G06F 16/735; H04N 21/252; H04N 21/4508; H04N 21/2347

(57) ABSTRACT

Methods, systems are computer program products are provided for restricting video content including displaying, via an interface, an output of a portion of a video that is recommended for preview to facilitate restricting of the portion of the video during playback for one or more audience groups, receiving, via the interface and for a user profile, an indication of whether to restrict the portion of the video during playback for the one or more audience groups, and storing the indication for use in restricting the portion of the video during playback for the one or more audience groups.

### BACKGROUND

Video streaming services are provided that allow users to stream video from a server to a personal device, such as computers, televisions, phones, tablets, etc. Video streaming services typically require a user to establish a user profile with the service, which may be subscription based, in order to access and play the videos. Video content can have a rating that is representative of the content in the video, such as Restricted (R), Parental Guidance Suggested (PG), General (G), etc., and/or can have tags indicating if the video content has violence, adult situations, offensive language, smoking, etc. These ratings and tags can assist a user in determining what video content they would like to play for themselves and/or for family members. In some examples, a user profile can setup family member profiles, which may be restricted as to what content can be played, which may be based on these ratings or tags. The ratings and tags, however, may not accurately represent all situations in the video content, and/or the ratings and tags may prevent family members from viewing video content that is generally not offensive other than a small selection of one or more scenes.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a computer-implemented method for restricting video content is provided that includes displaying, via an interface, an output of a portion of a video that is recommended for preview to facilitate restricting of the portion of the video during playback for one or more audience groups, receiving, via the interface and for a user profile, an indication of whether to restrict the portion of the video during playback for the one or more audience groups, and storing the indication for use in restricting the portion of the video during playback for the one or more audience groups.

In another example, a device for restricting video content is provided that includes a memory storing instructions, and at least one processor coupled to the memory. The at least one processor is configured to execute the instructions to display, via an interface, an output of a portion of a video that is recommended for preview to facilitate restricting of the portion of the video during playback for one or more audience groups, receive, via the interface and for a user profile, an indication of whether to restrict the portion of the video during playback for the one or more audience groups, and store the indication for use in restricting the portion of the video during playback for the one or more audience groups.

In another example, a computer-readable device is provided that stores instructions thereon that, when executed by at least one computing device, causes the at least one computing device to perform operations for restricting video content. The operations include displaying, via an interface, an output of a portion of a video that is recommended for preview to facilitate restricting of the portion of the video during playback for one or more audience groups, receiving, via the interface and for a user profile, an indication of whether to restrict the portion of the video during playback for the one or more audience groups, and storing the indication for use in restricting the portion of the video during playback for the one or more audience groups.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for restricting video content, in accordance with aspects described herein.

FIG. 2 is a flow diagram of an example of a method for restricting video content, in accordance with aspects described herein.

FIG. 3 is a flow diagram of an example of a method for receiving an indication of a portion of a video to preview for restriction, in accordance with aspects described herein.

FIG. 4 illustrates an example of a service architecture for providing video content restriction in accordance with aspects described herein.

FIG. 5 is a schematic diagram of an example of a service architecture to detect restricted content via dialogues using speech-to-text processing or topic modelling, in accordance with aspects described herein.

FIG. 6 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to facilitating restriction of video content by providing portions of the video content for preview and an indication of whether to restrict the portions of the video content when playing the video content for one or more audience groups. In an example, given video content, such as a movie, a television show, etc., a user interface can be provided to identify, represent, or otherwise show portions of the video content that are recommended for review for possible restriction. The user interface can facilitate restriction of the portions of the video content based on receiving an input indicating to restrict the portions of the content for one or more audience groups.

In an example, the portions of the video content to be recommended for review can be selected using one or more of various mechanisms, including content-based mechanisms, such as an artificial intelligence (AI)-based mechanism that can identify the portions of the video content based on providing natural language of closed captioning or speech-to-text processing of dialog as input to a machine learning (ML) model trained on sensitive phrases, or providing images from scenes or frames of the video as input to a ML model trained on known sensitive images. In another example, a ML model-based recommendation system using context-based filtering or collaborative filtering can be trained based on the natural language of closed captioning or speech-to-text processing or the image content of other scene identified by the similar users as to be restricted (e.g., for a given audience group). In another example, the mechanisms for selecting the portions of the video content can include a contextual collaborative filtering based recommendation system, which can select the portions of the video content based on other users (e.g., users having a similar provide as the user to which the preview is being provided or otherwise) indicating to restrict the portions of the video content, select portions of the video content based on the portions being similar to other portions of other video content that other users (e.g., users having a similar profile as the user to which the preview is being provided or otherwise) have identified for restriction, etc. In this regard, customized video restriction can be provided using custom segmentation of the video and recommendations for portions of the video to preview, where the recommendations can be AI-based or otherwise content-based, collaborative filtering-based, etc.

AI-based models can provide recommendations regarding safe video content boundaries with the preview option so that users/viewers can quickly take a decision to lock the safe content boundaries rather than watching every scene manually to mark the safe points. This intelligence can be extended to the collaborative filtering-based models by surfacing additional recommendations by analyzing restriction decisions or other configurations made by other users to make it more efficient and accurate. This model can, in some examples described herein, become a fusion of auto intelligence with human intelligence combined to surface the recommendations in a more accurate manner. This model or design can help parents to control any videos and translate them to become a safe content for their family and ensure children's safety and/or positive impact through the safe content video.

In one example, a user can select the type of mechanism to be used in generating the recommendations for preview, such as AI-based mechanisms, collaborative filtering-based mechanisms, a combination thereof, and/or the like. Presenting the recommendations for preview in this regard may allow a user to more easily restrict content in videos for certain audience groups related to the user (e.g., kids of certain ages), and the restricted content can be removed from the video during playback. In these examples, the user may not need to watch the entire video content to identify material for restriction, but may rather just view and advise on the recommended portions of the video content, which can save time and improve user experience in restricting video content.

In accordance with aspects described herein. restricted content can be detected via AI/Image censor model and natural language processing (NLP)-based speech-to-text processing of video content to indicate the likelihood of having sensitive content in particular frames. In some aspects, along with automatic detection, recommendation of sensitive content can be provided using collaborative filtering-based recommendations from similar user profiles and using content-based recommendation of a user profile history. In some aspects, restricted frames gathered through automated detection of restricted content and collaborative filtering-based recommendations can be shown via user interface to the user as a preview, and/or the user interface may allow the user to indicate whether to restrict the content, as described further herein.

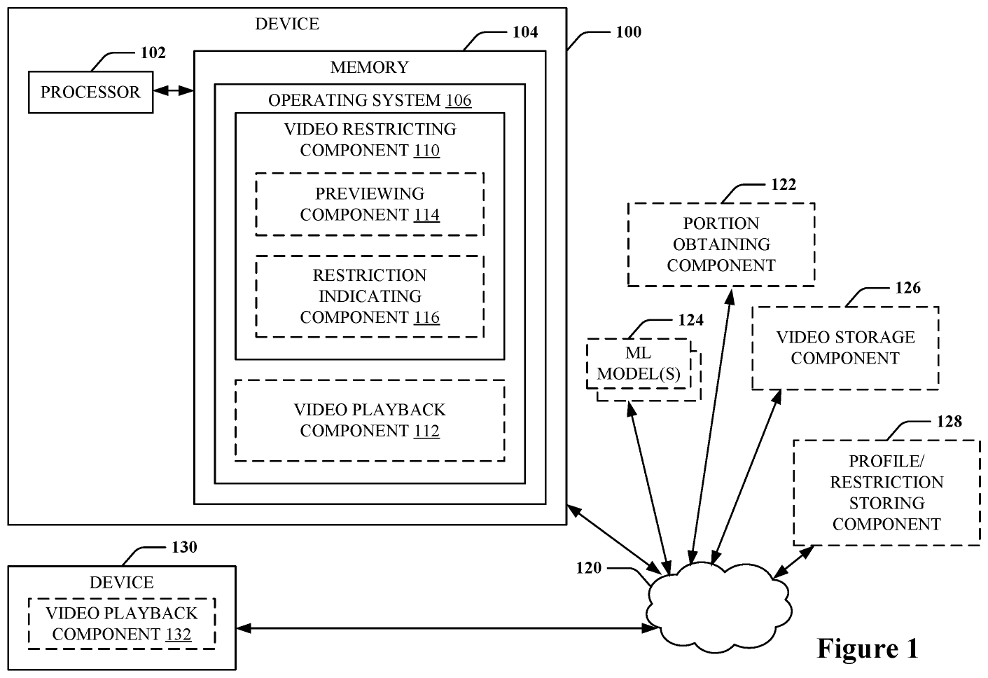

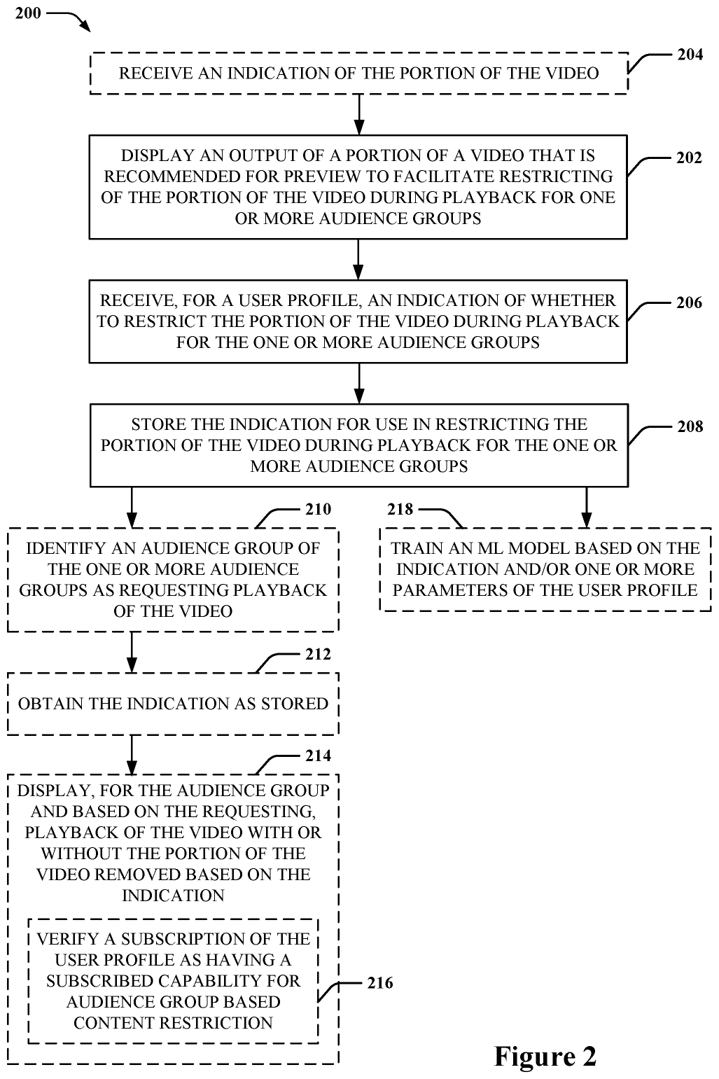

Turning now to FIGS. 1-6, examples are depicted with reference to one or more components and one or more methods that may perform the actions or operations described herein, where components and/or actions/operations in dashed line may be optional. Although the operations described below in FIGS. 2, 3, and 5 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) for performing functions related to restricting video content. In an example, device 100 can include a processor 102 and/or memory 104 configured to execute or store instructions or other parameters related to providing an operating system 106, which can execute one or more applications or processes, such as, but not limited to, a video restricting component 110 for defining one or more video restrictions for one or more user profiles or audience groups within the user profiles, and/or a video playback component 112 for playing video based on the one or more defined video restrictions for a given user profile or audience group. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein.

For example, video restricting component 110 can include a previewing component 114 that can display an output of a portion of a video for preview, and/or a restriction indicating component 116 that can receive an input of whether to restrict the portion of the video for a user profile, for one or more audience groups associated with the user profile, etc., which can be based on display of the preview. In one example, video restricting component 110 can receive the portions of the video for preview and/or can store restriction indications via memory 104 local to the device 100 and/or via other components across a network 120. Indeed, substantially any components described herein can be within the device 100 or in other devices or nodes distributed in location and accessible via network 120.

In an example, a portion obtaining component 122 can be provided (e.g., in device 100 or in another node accessible via network 120) for obtaining portions of a video for preview by the video restricting component 110. In various examples described herein, portion obtaining component 122 can leverage one or more ML models 124 to determine which portions of the video to present for preview so a user does not have to view the entire video to filter or restrict content for certain audience groups. In addition, for example, a video storage component 126 can be provided (e.g., in device 100 or in another node accessible via network 120) for storing video that can be accessed and played by a video playback component 112. For example, video storage component 126 can be operated by a video streaming service, and video playback component 112 of the device 100 (and/or other video playback components 132 of other devices 130) can receive the video streaming service such to stream videos from video storage component 126.

In addition, for example, a profile/restriction storing component 128 can be provided (e.g., in device 100 or in another node accessible via network 120) for storing user profile information (e.g., profile demographics, family user information or audience groups related to the user profile, etc.) and/or restrictions indicated for the user profile or related audience groups. In an example, video playback component 112, or a video playback component 132 of another device 130, can communicate with the profile/restriction storing component 128 based on an associated user profile to determine restrictions for playing video content stored in video storage component 126 for the user profile and/or for one or more associated audience groups.

In some examples, streaming video subscription providers, which store videos in the video storage component 126, can upload content to the portion obtaining component 122, which can be part of a product AI-based recommendation model that can process the content based on the rating policy and/or apply image processing algorithms to segment the video to detect portions (e.g., scenes, frames, etc.) with different types of sensitive content, such as violent/adult content, adult language, smoking, etc., and the output of such processed content boundary can be persisted in cloud storage. In an example, the AI model output can be blended with the other restrictions indicated and stored in other users' profiles, in profile/restriction storing component 128, which may be part of the same product, to generate blended recommendations. These two options can be surfaced to users via video restricting component 110 at the time of customization.

Users can have an option, presented on a user interface by video restricting component 110, to choose AI-based recommendations (Full AI or AI plus blended (human intelligence based on other user profiles), which may include manual customization to configure the boundaries of the content based on the user's preferences. The recommendation option can be provided to portion obtaining component 122 to impact how the portion obtaining component 122 obtains and provides the portions of the video content to the video restricting component 110 (e.g., whether by using AI-based recommendation based on one or more ML model(s) 124, and/or whether to provide recommendations based on restriction indications from other user profiles stored by profile/restriction storing component 128.

This solution can be leveraged in enterprise/commerce services as well to restrict training videos content for any enterprise/commerce services where certain contents may not be relevant to certain regions, and portion obtaining component 122 can obtain such portions for review to allow indication of restrictions according to the region and the policy. For example, in commerce world, training videos should not have a content related to “Invoice whitelisting,” as whitelisting is indicating a category of a particular population. As such, any of this content can be presented for preview and possible indication of restriction (e.g., for profiles associated with US-based engineers).

In addition, in some examples, schools/institutions in addition to households may benefit from this model as they can customize the video content to align with their institutions culture and baseline principles to become safe content, as the producer of the original video cannot customize the content for every user, as he cannot gauge everyone need including cultural values.

FIG. 2 is a flowchart of an example of a method 200 for restricting video content. For example, method 200 can be performed by a device 100 and/or one or more components thereof to facilitate displaying previous of portions of video content and/or facilitate restriction thereof.

In method 200, at action 202, an output of a portion of a video that is recommended for preview to facilitate restricting of the portion of the video during playback for one or more audience groups can be displayed. In an example, previewing component 114 of a video restricting component 110, e.g., in conjunction with processor 102, memory 104, operating system 106, etc., can display the output of the portion of the video that is recommended for preview to facilitate restricting the portion of the video during playback for one or more audience groups. For example, previewing component 114 can display the portion of the video on a user interface, where the user interface can also allow for indicating the portion of the video as restricted for one or more audience groups related to the user profile. In this regard, video restricting component 110 can allow the user to preview a limited number of portions of the video without having the view the entire video to setup restrictions.

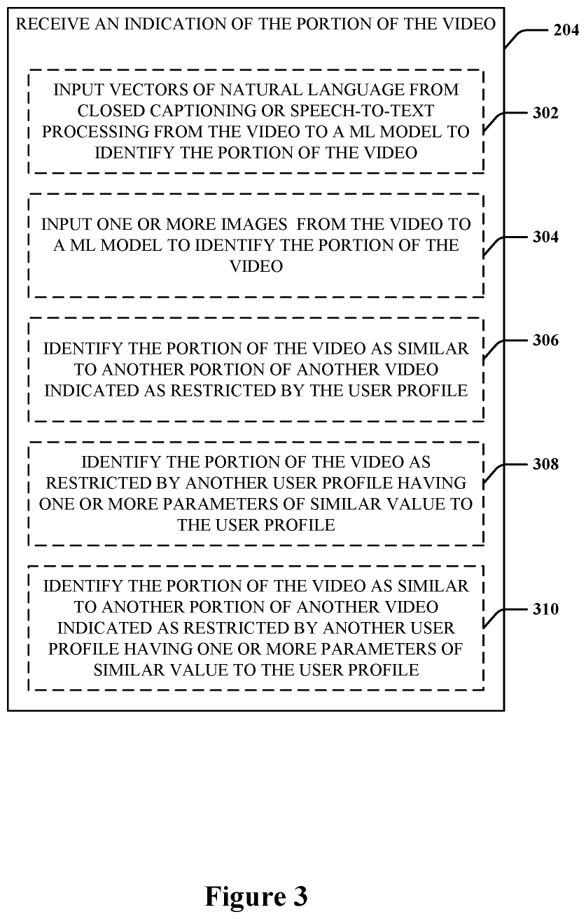

In method 200, optionally at action 204, an indication of the portion of the video can be received. In an example, previewing component 114 of a video restricting component 110, e.g., in conjunction with processor 102, memory 104, operating system 106, etc., can receive (e.g., from a portion obtaining component 122) the indication of the portion of the video. For example, for a given video to stream from video storage component 126, portion obtaining component 122 can provide video restricting component 110 with a list of portions of the video to preview for possible content restriction. For example, the list of portions may include a start and stop time of each portion. In any case, previewing component 114 can display each portion in the list of portion (or allow the user to select the portion) along with options to preview the portion and indicate whether to restrict the portion for one or more audience groups associated with the user profile. Various options for receiving the indication are shown in FIG. 3.

FIG. 3 illustrates a flow chart of examples of actions or operations resulting in receiving the indication of the portion of the video. Receiving the indication at action 204 can include or be based on one or more of the actions in FIG. 3. In an example, which actions to include can be based on a selection via an interface of video restricting component 110 indicating which types of recommendations are requested, as described further herein. In one example, portion obtaining component 122 may apply the actions to obtain the portion of the video, and video restricting component 110 can accordingly receive the indication of the portion of the video from portion obtaining component 122. For example, as described above and further herein, the recommendations can be context-based or based on collaborative filtering.

For example, in receiving the indication of the portion of the video at action 204, optionally at action 302, vectors of natural language from closed captioning or speech-to-text processing from the video can be input to a ML model to identify the portion of the video. In an example, portion obtaining component 122, e.g., based on a request from the video restricting component 110, e.g., and/or in conjunction with processor 102, memory 104, operating system 106, etc., of a node operating the portion obtaining component 122, can input the vectors of natural language from closed captioning or speech-to-text processing from the video to a ML model 124 to identify the portion of the video. For example, portion obtaining component 122 can obtain the closed captioning text associated with the video content or can perform (or receive a result or) Speech-to-text processing of dialogues of the video content (e.g., of an audio track of the video), and can provide the natural language as input to the ML model 124. The ML model 124, for example, can be trained on natural language that is determined to include sensitive material to provide context-based recommendations. For any portions of the video content determined, based on the output of the ML model 124 given the natural language input, to include sensitive material, portion obtaining component 122 can determine a start and stop time or other identifying information for the portion of the video content, and can provide related information in the indication to the video restricting component 110.

In one example, the ML model 124 can be trained using unsupervised topic modeling, which can eradicate the need of domain knowledge expertise for identifying scenes. Topic modeling applied on set of frames, for example, can give a number, n, of topics can indicate scenarios of restricted/sensitive content. The topic models can be mapped to an existing dictionary of offensive words or other words indicating restricted/sensitive content. If topics in a set of frames map to restricted/sensitive content, the start and stop time of the frame can be saved and can be used to skip over the frame in subsequent playback for a given audience group.

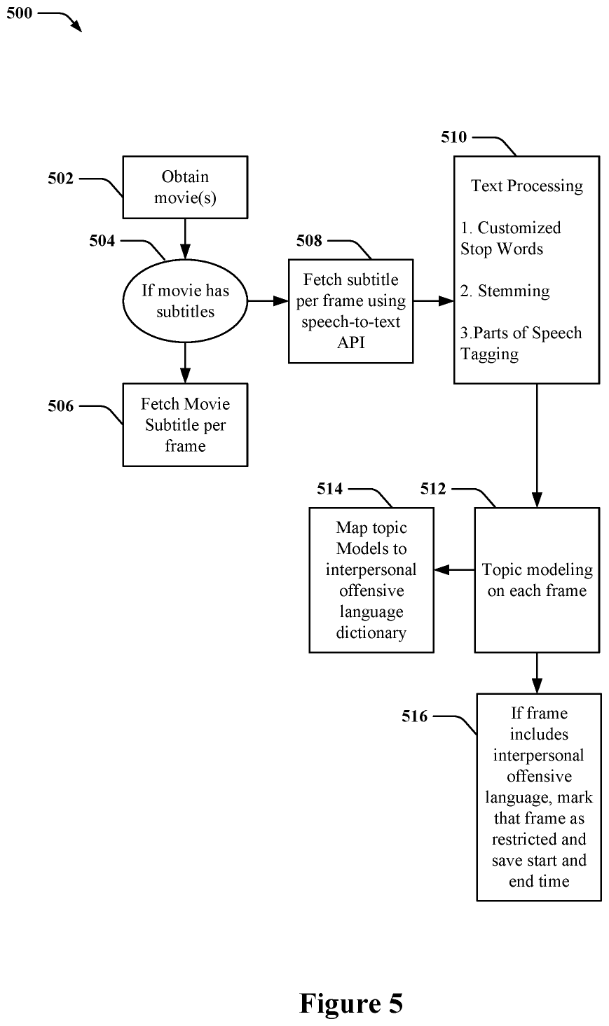

FIG. 5 illustrates an example of a service architecture 500 to detect restricted content via dialogues using speech-to-text processing or topic modelling, in accordance with aspects described herein. In accordance with service architecture 500, for example, dialogues can be utilized to detect restricted content in a frame. One or more movies can be obtained at 502. If the movie is determined to have subtitles at 504 (e.g., in metadata received with the movie at 502, the movie subtitles can be fetched per frame at 506. If not, the subtitles can be fetched or otherwise determined using a speech-to-text application or application programming interface (API) at 508. At 510, text processing can be performed on the subtitles, or on the dialogues of each frame, which may include using Natural Language Processing techniques such as removal of stop words, stemming and/or lemmatization and Parts of Speech Tagging.

After text processing/pre-processing, topic modelling can be performed at 512 to map topic models to terms in an interpersonal offensive language dictionary at 514 and/or to possibly detect occurrence of offensive language in the dialogues. In an example, topic modelling can be performed on each frame to fetch a top number of topic models (e.g., top 5 topic models) at 512. If any of the topic models map to interpersonal offensive words or phrases, the frame can be marked as restricted and start and end time of that frame can be saved for use during playback of the movie, as described herein (e.g., to skip over or otherwise remove the restricted content during playback).

Referring back to FIG. 3, in another example, in receiving the indication of the portion of the video at action 204, optionally at action 304, one or more images from the video can be input to a ML model to identify the portion of the video. In an example, portion obtaining component 122, e.g., based on a request from the video restricting component 110, e.g., and/or in conjunction with processor 102, memory 104, operating system 106, etc., of a node operating the portion obtaining component 122, can input the one or more images from the video to a ML model 124 to identify the portion of the video. For example, portion obtaining component 122 can provide images from the video stream as input to the ML model 124. The ML model 124, for example, can be trained on images that are determined to include sensitive material. For any portions of the video content determined, based on the output of the ML model 124 given the image input, to include sensitive material, portion obtaining component 122 can determine a start and stop time or other identifying information for the portion of the video content, and can provide related information in the indication to the video restricting component 110.

In another example, in receiving the indication of the portion of the video at action 204, optionally at action 306, a portion of the video can be identified as similar to another portion of another video indicated as restricted by the user profile. In an example, portion obtaining component 122, e.g., based on a request from the video restricting component 110, e.g., and/or in conjunction with processor 102, memory 104, operating system 106, etc., of a node operating the portion obtaining component 122, can identify the portion of the video as similar to another portion of another video indicated as restricted by the user profile. In one example, portion obtaining component 122 can input natural text or images of the other video portions indicated, as restricted by the user profile, to the ML model 124 (e.g., in training the ML model 124), such that the ML model 124 can output similar portions of the video. In one example, the ML model 124 can be specific to the user profile or can be specific to certain user profile parameter values (e.g., similar parameter values for one or more parameters, such as demographic or cultural parameters, family member parameters, country, region, language preference, gender, etc.), such that user profiles having similar parameter values can use the same ML model 124 to identify possible portions of the video for preview as collaborative filtering-based recommendations. In another example, portion obtaining component 122 can obtain natural text of portions of the other video content that was indicated by the user profile to be restricted for one or more audience groups, and can detect the same or similar natural text in portions of the video to provide the portions for preview. For example, portion obtaining component 122 can obtain natural text of portions of the other video content indicated as restricted from the profile/restriction storing component 128.

In another example, in receiving the indication of the portion of the video at action 204, optionally at action 308, a portion of the video can be identified as restricted by another user profile having one or more parameters of similar value to the user profile. In an example, portion obtaining component 122, e.g., based on a request from the video restricting component 110, e.g., and/or in conjunction with processor 102, memory 104, operating system 106, etc., of a node operating the portion obtaining component 122, can identify the portion of the video as restricted by another user profile having one or more parameters of similar (or same) value to the user profile. In one example, portion obtaining component 122 can input natural text or images of the video portions indicated, as restricted by the other user profiles, to the ML model 124 (e.g., in training the ML model 124), such that the ML model 124 can output similar portions of the video. In one example, the ML model 124 can be specific to the user profile or can be specific to certain user profile parameter values (e.g., similar parameter values for one or more parameters, such as demographic or cultural parameters, family member parameters, country, region, language preference, gender, etc.), such that user profiles having similar parameter values can use the same ML model 124 to identify possible portions of the video for preview as collaborative filtering-based recommendations, as described.

In another example, portion obtaining component 122 can obtain natural text of portions of the other video content that was indicated by the other user profile to be restricted for one or more audience groups, and can detect the same or similar natural text in portions of the video to provide the portions for preview for the user profile. In this regard, for example, portion obtaining component 122 can identify the portion of the video using content based collaborative filtering to identify the video as restricted by another user profile. For example, portion obtaining component 122 can obtain natural text of portions of the other video content indicated as restricted by the other user profile from the profile/restriction storing component 128. In one example, portion obtaining component 122 can obtain this information based on determining that certain parameters values in the user profile and other user profile are similar, based on inputting the user profiles into a ML model 124 to obtain a similarity score or confidence, etc.

In another example, in receiving the indication of the portion of the video at action 204, optionally at action 310, a portion of the video can be identified as similar to another portion of another video restricted by another user profile having one or more parameters of similar value to the user profile. In an example, portion obtaining component 122, e.g., based on a request from the video restricting component 110, e.g., and/or in conjunction with processor 102, memory 104, operating system 106, etc., of a node operating the portion obtaining component 122, can identify the portion of the video as similar to another portion of another video restricted by another user profile having one or more parameters of similar (or same) value to the user profile. In one example, portion obtaining component 122 can input natural text or images of the other video portions indicated, as restricted by the other user profiles, to the ML model 124 (e.g., in training the ML model 124), such that the ML model 124 can output portions of the video that are similar to the other portions of other videos. In one example, the ML model 124 can be specific to the user profile or can be specific to certain user profile parameter values (e.g., similar parameter values for one or more parameters, such as demographic or cultural parameters, family member parameters, country, region, language preference, gender, etc.), such that user profiles having similar parameter values can use the same ML model 124 to identify possible portions of the video for preview as collaborative filtering-based recommendations, as described. In one example, portion obtaining component 122 can obtain this information based on determining that certain parameters values in the user profile and other user profile are similar, based on inputting the user profiles into a ML model 124 to obtain a similarity score or confidence, etc.

Referring back to FIG. 2, in method 200, at action 206, an indication of whether to restrict the portion of the video during playback for the one or more audience groups can be received for the user profile. In an example, restriction indicating component 116 of a video restricting component 110, e.g., in conjunction with processor 102, memory 104, operating system 106, etc., can receive, for the user profile, the indication of whether to restrict the portion of the video during playback for the one or more audience groups. For example, video restricting component 110 can provide an option, via the user interface, to indicate restriction of the portion of the video for at least one or more audience groups. In an example, the user profile can be associated with different audience groups, which may be specified in profile/restriction storing component 128. For example, the user profile may indicate an audience group for each of multiple family members of the user profile. For example, the audience groups may be defined by age or age range, content preferences, and/or the like.

In one example, in previewing the content, video restricting component 110 can offer options to indicate whether to restrict the content for each of multiple audience groups associated with the user profile. In this regard, for example, the portion may be restricted for one audience group but not another. In a specific example, video restricting component 110 can provide a first selection to restrict the content for an age 8 and under audience group (which may correspond to one child in the household) and a second selection to restrict the content for an age 9-12 audience group (which may correspond to another child in the household). As such, for example, a user may indicate restriction of the portion of the video for the age 8 and under audience group but not for the age 9-12 audience group. In any case, the restriction indications can be stored for the video (e.g., by profile/restriction storing component 128) and can be accessed by a video playback component 112 or 132 when playing a video for a given audience group associated with the user profile.

In method 200, at action 208, the indication can be stored for use in restricting the portion of the video during playback for the one or more audience groups. In an example, restriction indicating component 116 of a video restricting component 110, e.g., in conjunction with processor 102, memory 104, operating system 106, etc., can store, e.g., via profile/restriction storing component 128, the indication for use in restricting the portion of the video during playback for the one or more audience groups. For example, restriction indicating component 116 can store the indication along with one or more parameters indicating the portion of the video (e.g., a start time and end time or other identifying information within the video). For example, restriction indicating component 116 can store the indication in the user profile information and/or as related to one or more audience groups, as described.

In method 200, optionally at action 210, an audience group of the one or more audience groups as requesting playback of the video can be identified. In an example, video playback component 112 or 132, e.g., in conjunction with processor 102, memory 104, operating system 106, etc. (or similar components of device 130), can identify the audience group of the one or more audience groups as requesting playback of the video. For example, video playback component 112 or 132 can receive a request to access the video from the video streaming service (e.g., from video storage component 126), and the request can be associated with the user profile and/or the corresponding audience group.

In method 200, optionally at action 212, the indication as stored can be obtained. In an example, video playback component 112 or 132, e.g., in conjunction with processor 102, memory 104, operating system 106, etc. (or similar components of device 130), can obtain the indication as stored. For example, video playback component 112 or 132 can obtain the indication to restrict the portion of the video, e.g., along with indications to restrict other portions of the video, from profile/restriction storing component 128. For example, video playback component 112 or 132 can obtain the user profile associated with the video playback request and can obtain the restriction indications for the user profile that are associated with the video and/or associated with a certain audience group.

In method 200, optionally at action 214, playback of the video can be displayed, for the audience group and based on the requesting, with or without the portion of the video removed based on the indication. In an example, video playback component 112 or 132, e.g., in conjunction with processor 102, memory 104, operating system 106, etc. (or similar components of device 130), can display, for the audience group and based on the requesting, playback of the video with or without the portion of the video removed based on the indication. For example, video playback component 112 or 132 can obtain the list of restriction indications for the audience group requesting playback, as described, and can remove or skip over the portions of video indicated as restricted. For example, video playback component 112 or 132 can, for each restriction indication, determine the start time and end time, and can remove the portions of the video from the playback stream or otherwise skip starting at the start time and continuing at the end time, etc. during playback.

In one example, content restriction may be subscription based, as described. Accordingly, in one example in method 200, optionally at action 216, a subscription of the user profile as having a subscribed capability for audience group based content restriction can be verified. In an example, video playback component 112 or 132, e.g., in conjunction with processor 102, memory 104, operating system 106, etc. (or similar components of device 130), can verify the subscription of the user profile as having the subscribed capability for audience group based content restriction before obtaining the restriction indications or otherwise restricting content in this regard. In one example, the subscribed capability can be indicated per audience group, such that the user may have a different subscription level for restricting for one audience group (or a specific audience group) that for restricting more than one audience group (or a different specific audience group), etc.

In other examples, the restriction indication can be used to train one or more ML models 124, as described. In method 200, optionally at action 218, an ML model can be trained based on the indication and/or one or more parameters of the user profile. In an example, profile/restriction storing component 128, e.g., in conjunction with processor 102, memory 104, operating system 106, etc. of a node that includes profile/restriction storing component 128, can train the ML model (e.g., one or more of ML models 124) based on the indication and/or the one or more parameters of the user profile. For example, profile/restriction storing component 128 can train an ML model 124 based on the portion of video indicated as restricted, properties of the portion of the video (e.g., natural language in the audio or closed captioning of the portion of the video, images in the portion of the video, etc.), user profile characteristics (e.g., demographic parameters, cultural parameters, family member parameters, etc.). In an example, as described, portion obtaining component 122 can use this trained ML model 124 for recommending portions of video (e.g., the portion of the video used to train the ML model 124 or similar portions of the video or other videos) for preview for certain user profiles or associated audience groups. In addition, as described for example, profile/restriction storing component 128 can train an ML model 124 can train the ML model based on the natural language using K-means applied on probabilities of keywords generated for each topic model.

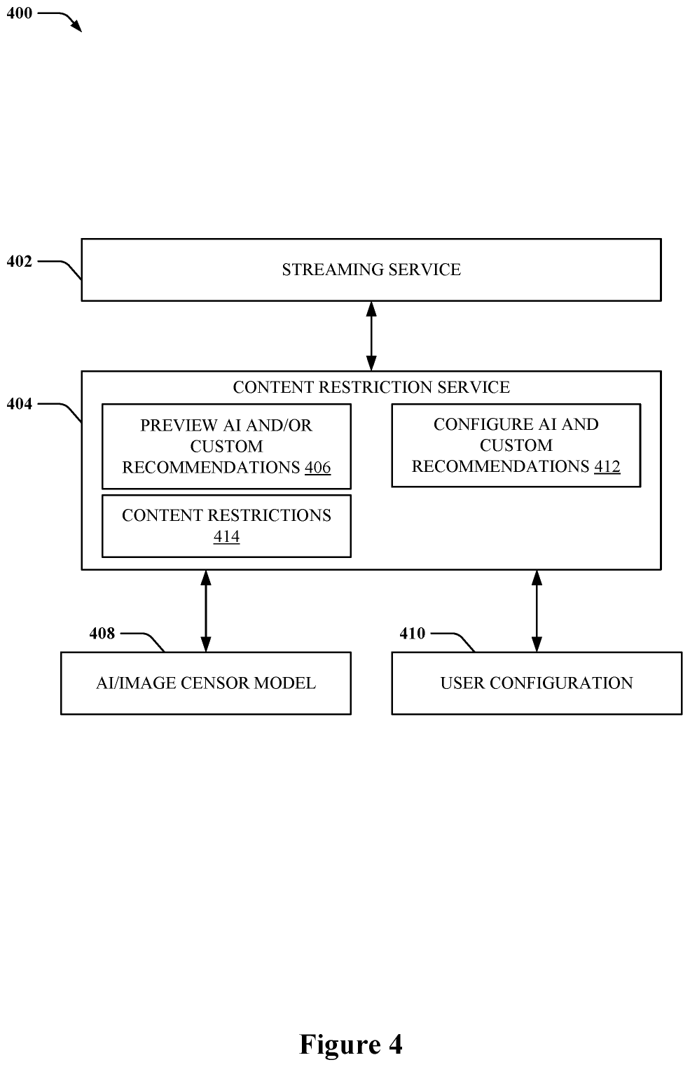

FIG. 4 illustrates an example of a service architecture 400 for providing video content restriction in accordance with aspects described herein. Service architecture 400 can include a streaming service 402 that can provide streaming video content to various users based on a user profile or subscription with the streaming service. The streaming service can communicate with a content restriction service 404 to obtain information for restricting content in during video streaming for the given user profile. For example, user profiles of the streaming service 402 may be associated with user profiles in the content restriction service 404. In one example, a user can subscribe to the streaming service 402 (and/or multiple streaming services) and separately to the content restriction service 404, where the content restriction service 404 can interact with the streaming service 402 (and/or multiple streaming services) to provide restriction information the that streaming service 402 (and/or multiple streaming services) can use when streaming video content for the user.

In an example, streaming service can access the video content for playback via video storage component 126. Content restriction service 404 can also access the video for content restriction via the video storage component 126, as described. In addition, as described, content restriction service 404 can be provided by a device 100, or one more components distributed over multiple devices, which may include the video restricting component 110 and/or components thereof (e.g., previewing component 114, restriction indicating component 116, etc.), portion obtaining component 122, ML models 124, profile/restriction storing component 128, etc. Content restriction service 404 can access these components to facilitate definition of restrictions of portions of a video for certain user profiles or audience groups, selecting portions of the video content to preview for indicating restrictions, enforcement of indicated restrictions when streaming video content, etc.

In an example, content restriction service 404 can include a process to preview AI and/or custom recommendations 406 of portions of videos that may have sensitive material. As described, the AI-based recommendations may be provided by a ML model, such as n AI/image censor model 408 that can take vectors of natural language from closed captioning or speech-to-text processing from an audio track of the video, or vectors of images from the video, as input, and can indicate one or more portions of the video for preview. In addition, as described, the custom recommendations can be provided based on user configurations 410 of the user or other user profiles in the content restriction service, such as similar restrictions provided for the video by other user profiles, similar restrictions provided by the user or other user profiles for similar portions of other videos, etc. In an example, the user may enable AI-based recommendations, custom recommendations, additional types of recommendations, and/or a combination thereof, for preview. In this regard, for example, content restriction service 404 can include a process to configure AI and custom recommendations 412, which may providing an option on a user interface for the user to configure the types of recommendations.

For example, content restriction service 404 can include a process for content restrictions 414, which can allow the user to indicate content restriction for the portion of the video for one or more audience groups that may be associated with the user profile. Content restriction service 404 can store the content restrictions 414 as part of, or as meta data associated with, the user profile, and the content restrictions 414 may be specific for a given audience group. In any case, for example, content restriction service 404 can provide content restriction information to the streaming service 402 for a given user profile or related audience group to allow the streaming service 402 to restrict video streaming content based on the restrictions. In other examples, as described herein, content restriction service 404 can also use the content restrictions 414 to generate other recommendations for content restriction (e.g., for the same user profile or different user profiles), to train ML models that provide recommendations for AI-based content restrictions, to include in user configurations for custom recommendations, etc.

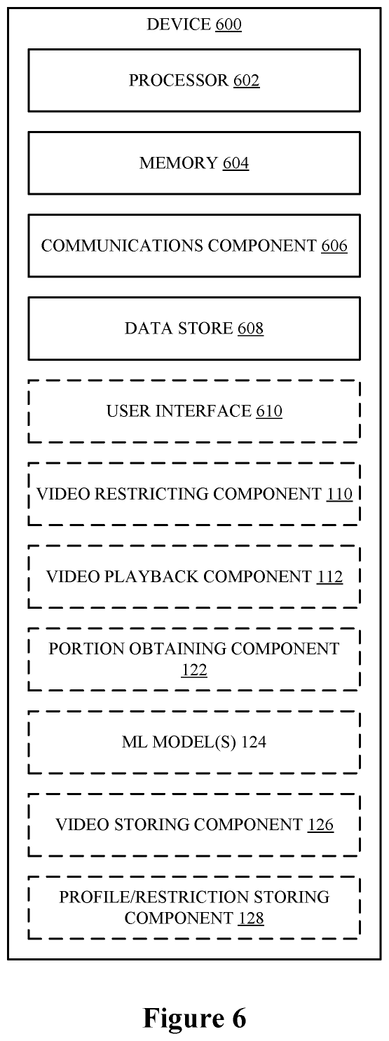

FIG. 6 illustrates an example of device 600 including additional optional component details as those shown in FIG. 1. In one aspect, device 600 may include processor 602, which may be similar to processor 102 for carrying out processing functions associated with one or more of components and functions described herein. Processor 602 can include a single or multiple set of processors or multi-core processors. Moreover, processor 602 can be implemented as an integrated processing system and/or a distributed processing system.

Device 600 may further include memory 604, which may be similar to memory 104 such as for storing local versions of operating systems (or components thereof) and/or applications being executed by processor 602, such as a video restricting component 110, video playback component 112, portion obtaining component 122, ML model(s) 124, video storage component 126, profile/restriction storing component 128, etc. Memory 604 can include a type of memory usable by a computer, such as random access memory (RAM), read only memory (ROM), tapes, magnetic discs, optical discs, volatile memory, non-volatile memory, and any combination thereof.

Further, device 600 may include a communications component 606 that provides for establishing and maintaining communications with one or more other devices, parties, entities, etc. utilizing hardware, software, and services as described herein. Communications component 606 may carry communications between components on device 600, as well as between device 600 and external devices, such as devices located across a communications network and/or devices serially or locally connected to device 600. For example, communications component 606 may include one or more buses, and may further include transmit chain components and receive chain components associated with a wireless or wired transmitter and receiver, respectively, operable for interfacing with external devices.

Additionally, device 600 may include a data store 608, which can be any suitable combination of hardware and/or software, that provides for mass storage of information, databases, and programs employed in connection with aspects described herein. For example, data store 608 may be or may include a data repository for operating systems (or components thereof), applications, related parameters, etc.) not currently being executed by processor 602. In addition, data store 608 may be a data repository for video restricting component 110, video playback component 112, portion obtaining component 122, ML model(s) 124, video storage component 126, profile/restriction storing component 128, and/or one or more other components of the device 600.

Device 600 may optionally include a user interface component 610 operable to receive inputs from a user of device 600 and further operable to generate outputs for presentation to the user. User interface component 610 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for restricting video content, comprising:
receiving recommendations of portions of a video to display for review to facilitate possibly restricting the portions of the video during playback for one or more audience groups, wherein receiving the recommendations includes receiving at least a first recommendation of a first portion of the video as a context-based recommendation and receiving a second recommendation of a second portion of the video as a collaborative-based recommendation;
displaying, via an interface, an output of the portions of the video that are recommended for preview to facilitate possibly restricting the portions of the video during playback for the one or more audience groups;
receiving, via the interface and for a user profile, indications of whether to restrict the portions of the video during playback for the one or more audience groups; and
storing the indications for use in restricting the portions of the video during playback for the one or more audience groups.

2. The computer-implemented method of claim 1, further comprising:
identifying an audience group of the one or more audience groups requesting playback of the video;
obtaining, based on requesting playback of the video, the indications as stored; and
displaying, for the audience group and based on the requesting, playback of the video with or without the portions of the video removed based on the indications.

3. The computer-implemented method of claim 2, wherein displaying playback of the video for the audience group is based on verifying a subscription of the user profile as having a subscribed capability for audience group based content restriction.

4. The computer-implemented method of claim 1, further comprising receiving the context-based recommendation based on input of at least one of vectors of natural language from closed captioning or speech-to-text processing of the video, or vectors of images from the video, to a machine learning (MEL) model to identify the first portion of the video as including restricted content.

5. The computer-implemented method of claim 4, further comprising training the MEL model based on an indication of the indications that corresponds to the first portion of the video having restricted content and one or more parameters of the user profile.

6. The computer-implemented method of claim 1, further comprising receiving the second recommendation based on collaborative filtering to identify the second portion of the video as restricted by another user profile having one or more parameters of similar value to the user profile.

7. The computer-implemented method of claim 1, further comprising receiving the second recommendation based on collaborative filtering to identify the second portion of the video as similar to another portion of another video that is indicated for the user profile as restricted.

8. The computer-implemented method of claim 7, wherein identifying the second portion of the video as similar to the another portion of the another video is based on inputting a vector associated with the second portion of the video to a machine learning (MEL) model and receiving an output of the another portion of the another video and identifying that the user profile indicated the another portion of another video as restricted.

9. The computer-implemented method of claim 8, further comprising training the MEL model based on an indication of the indications that corresponds to the second portion of the video and one or more parameters of the user profile.

10. The computer-implemented method of claim 1, wherein the user profile defines the one or more audience groups to include one or more family members based on an age of the one or more family members.

11. The computer-implemented method of claim 1, wherein displaying the output is based on a selection of a type of recommendation for providing previews for restriction as including one or more of context-based recommendations, collaborative-based recommendations of restrictions indicated by similar user profiles, or collaborative-based recommendations of the user profile for other videos.

12. A device for restricting video content, comprising:
a memory storing instructions; and
at least one processor coupled to the memory and configured to execute the instructions to:
receive recommendations of portions of a video to display for review to facilitate possibly restricting the portions of the video during playback for one or more audience groups, wherein receiving the recommendations includes receiving at least a first recommendation of a first portion of the video as a context-based recommendation and receiving a second recommendation of a second portion of the video as a collaborative-based recommendation;
display, via an interface, an output of the portions of the video that are recommended for preview to facilitate possibly restricting the portions of the video during playback for the one or more audience groups;
receive, via the interface and for a user profile, indications of whether to restrict the portions of the video during playback for the one or more audience groups; and
store the indications for use in restricting the portions of the video during playback for the one or more audience groups.

13. The device of claim 12, wherein the at least one processor is configured to execute the instructions to:
identify an audience group of the one or more audience groups requesting playback of the video;
obtain, based on requesting playback of the video, the indications as stored; and
display, for the audience group and based on the requesting, playback of the video with or without the portions of the video removed based on the indications.

14. The device of claim 13, wherein the at least one processor is configured to execute the instructions to display playback of the video for the audience group based on verifying a subscription of the user profile as having a subscribed capability for audience group based content restriction.

15. The device of claim 12, wherein the at least one processor is configured to execute the instructions to receive the context-based recommendation based on input of at least one of vectors of natural language from closed captioning or speech-to-text processing of the video, or vectors of images from the video, to a machine learning (ML) model to identify the first portion of the video as including restricted content.

16. The device of claim 12, wherein the at least one processor is configured to execute the instructions to receive the second recommendation based on collaborative filtering to identify the second portion of the video as restricted by another user profile having one or more parameters of similar value to the user profile.

17. The device of claim 12, wherein the at least one processor is configured to execute the instructions to receive the second recommendation based on collaborative filtering to identify the second portion of the video as similar to another portion of another video that is indicated for the user profile as restricted.

18. The device of claim 12, wherein the user profile defines the one or more audience groups to include one or more family members based on an age of the one or more family members.

19. A non-transitory computer-readable device storing instructions thereon that, when executed by at least one computing device, causes the at least one computing device to perform operations for restricting video content comprising:
receiving recommendations of portions of a video to display for review to facilitate possibly restricting the portions of the video during playback for one or more audience groups, wherein receiving the recommendations includes receiving at least a first recommendation of a first portion of the video as a context-based recommendation and receiving a second recommendation of a second portion of the video as a collaborative-based recommendation;
displaying, via an interface, an output of the portions of the video that are recommended for preview to facilitate possibly restricting the portions of the video during playback for the one or more audience groups;
receiving, via the interface and for a user profile, indications of whether to restrict the portions of the video during playback for the one or more audience groups; and
storing the indications for use in restricting the portions of the video during playback for the one or more audience groups.

20. The non-transitory computer-readable device of claim 19, the instructions causing the at least one computing device to perform operations comprising:
identifying an audience group of the one or more audience groups requesting playback of the video;
obtaining, based on requesting playback of the video, the indications as stored; and
displaying, for the audience group and based on the requesting, playback of the video with or without the portions of the video removed based on the indications.
